(19) United States
(12) Patent Application Publication
(10) Pub. No.: US 2021/0188020 A1
(43) Pub. Date: Jun. 24, 2021

(54) Pneumatic Tire

(71) Applicant: The Yokohama Rubber Co., LTD., Minato-ku, Tokyo (JP)

(72) Inventor: Masahiro Naruse, Hiratsuka-shi, Kanagawa (JP)

(21) Appl. No.: 16/757,352

(22) PCT Filed: Oct. 17, 2018
(86) PCT No.: PCT/JP2018/038738

§ 371 Date: Apr. 17, 2020

(30) Foreign Application Priority Data
Oct. 19, 2017 (JP) 2017-202643

(51) Int. Cl. B60C 19/00

(52) U.S. Cl. CPC B60C 19/002

(57) ABSTRACT

A pneumatic tire comprises a tread portion extending in a tire circumferential direction and having an annular shape; a pair of sidewall portions disposed on opposite sides of the tread portion; and a pair of bead portions disposed toward the inside of the sidewall portions in a tire radial direction; wherein a sound absorbing member is fixed via an adhesive layer to an inner surface of the tread portion along the tire circumferential direction, and when a temperature t of the sound absorbing member is at least in a range from −20° C. to 80° C., an elongation at break y (%) and the temperature t of the sound absorbing member satisfy relationships y≥t+100 and y≤2t+440.

### TECHNICAL FIELD

The present technology relates to a pneumatic tire and relates particularly to a pneumatic tire that can prevent a sound absorbing member from separating or breaking at low temperatures and can obtain a sound absorbing effect via the sound absorbing member during travel at high speeds.

### BACKGROUND ART

Cavernous resonance caused by vibration of air in a tire cavity portion is one cause of tire noise. Cavernous resonance occurs when a tread portion of a tire that comes into contact with a road surface when the vehicle is traveling vibrates due to the unevenness of the road surface and the vibration vibrates the air in the tire cavity portion. Since sound in a particular frequency band of the cavernous resonance is perceived as noise, it is important to reduce the level of sound pressure (noise level) in the frequency band and reduce cavernous resonance.

A known technique of reducing noise caused by such cavernous resonance includes mounting a sound absorbing member made of a porous material such as sponge on an inner surface of a tread portion on a tire inner surface using an elastic band (for example, see Japan Patent No. 4281874). However, in a case where the sound absorbing member is fixed with the elastic band, the elastic band may be deformed during travel at high speeds.

Another known method includes directly adhering and fixing a sound absorbing member to a tire inner surface has been proposed (for example, see Japan Patent No. 5267288). However, in a case where the sound absorbing member fixed to the tire inner surface has low elasticity, the sound absorbing member cannot follow the deformation of the tire at low temperatures. This leads to significant separation or breakage of the sound absorbing member. Additionally, in a case where the sound absorbing member fixed to the tire inner surface has high elasticity, the sound absorbing member is deformed with compression set during travel at high speeds and thus may not sufficiently provide a sound absorbing effect.

### SUMMARY

The present technology provides a pneumatic tire that can prevent a sound absorbing member from separating or breaking at low temperatures and can obtain a sound absorbing effect via the sound absorbing member during travel at high speeds.

A pneumatic tire includes:

a tread portion extending in a tire circumferential direction and having an annular shape;

a pair of sidewall portions disposed on opposite sides of the tread portion; and

a pair of bead portions disposed toward the inside of the sidewall portions in a tire radial direction; wherein

a sound absorbing member is fixed via an adhesive layer to an inner surface of the tread portion along the tire circumferential direction, and

when a temperature t (° C.) of the sound absorbing member is at least in a range from −20° C. to 80° C., an elongation at break y (%) and the temperature t (° C.) of the sound absorbing member satisfy relationships y≥t+100 and y≤2t+440.

A pneumatic tire according to an embodiment of the present technology includes a tread portion extending in a tire circumferential direction and having an annular shape; a pair of sidewall portions disposed on opposite sides of the tread portion; and a pair of bead portions disposed toward the inside of the sidewall portions in a tire radial direction; wherein a sound absorbing member is fixed via an adhesive layer to an inner surface of the tread portion along the tire circumferential direction, and

when a temperature t (° C.) of the sound absorbing member is at least in a range from −20° C. to 80° C., an elongation at break y (%) and the temperature t (° C.) of the sound absorbing member satisfy relationships y≥t+100 and y≤2t+440. This allows the sound absorbing effect of the sound absorbing member to be sufficiently ensured during travel at high speeds and separation and breakage of the sound absorbing member at low temperatures to be prevented.

In an embodiment of the present technology, preferably a hardness x (N/314 cm²) of the sound absorbing member and the elongation at break y (%) of the sound absorbing member satisfy relationships 130≤y≤500, y≤−21x+2770, and x>80. Accordingly, the sound absorbing member can be effectively prevented from separating or breaking under high loads or at low temperatures.

In an embodiment of the present technology, preferably the sound absorbing member has a density of from 10 kg/m³ to 30 kg/m³, and

a number of cells of the sound absorbing member is from 30 cells/25 mm to 80 cells/25 mm. Thus, the sound absorbing member can be given a low density and reduced weight, which leads to a reduction in rolling resistance. Additionally, the number of cells of the sound absorbing member appropriately is set, and thus fine air bubbles can be formed. This ensures a sufficient sound absorbing effect of the sound absorbing member.

In an embodiment of the present technology, preferably the sound absorbing member has a volume from 10% to 30% of a cavity volume of the tire. Thus, the sound absorbing effect of the sound absorbing member can be sufficiently ensured, which leads to an improvement in quietness.

In an embodiment of the present technology, preferably the sound absorbing member includes a single band-like body having a rectangular cross-sectional shape, and the band-like body forming the sound absorbing member is disposed straddling a tire equator. When the single sound absorbing member is disposed on the tire inner surface, the sound absorbing member can be effectively prevented from separating or breaking at low temperatures.

In an embodiment of the present technology, the pneumatic tire further includes a center land portion disposed on the tread portion on a tire equator and continuously extending around the tread portion around an entire tire circumference; and wherein

the sound absorbing member includes a first band-like body and a second band-like body, each one having a rectangular cross-sectional shape;

the first band-like body forming the sound absorbing member is disposed on one side in a tire lateral direction with respect to a position of 40% of a width of the center land portion from one end portion of the center land portion on the one side in the tire lateral direction to the other side in the tire lateral direction;

the second band-like body forming the sound absorbing member is disposed on the other side in the tire lateral direction with respect to a position of 40% of the width of the center land portion from one end portion of the center land portion on the other side in the tire lateral direction to the one side in the tire lateral direction; and

the first band-like body forming the sound absorbing member and the second band-like body forming the sound absorbing member are separated from each other by 60% or greater of the width of the center land portion. When a plurality of sound absorbing members are disposed on the tire inner surface, it is necessary to dispose the sound absorbing member in the vicinity of a region corresponding to a shoulder portion. Accordingly, the sound absorbing member disposed in the region may not sufficiently ensure high-speed durability. By disposing the plurality of sound absorbing members on the tire inner surface as described above, heat accumulation during travel at high speeds can be effectively inhibited, and high-speed durability can be increased. In addition, the noise performance and the high-speed durability can be improved in a well-balanced manner.

In an embodiment of the present technology, preferably the adhesive layer includes a double-sided adhesive tape, and the adhesive layer has a total thickness of 10 μm to 150 μm. Accordingly, the followability with respect to deformation during molding can be ensured.

In an embodiment of the present technology, preferably the sound absorbing member includes a missing portion in at least one section in the tire circumferential direction. Thus, the tire can endure, for a long period of time, expansion due to inflation of the tire or shear strain of an adhering surface due to contact and rolling of the tire.

In an embodiment of the present technology, the hardness of the sound absorbing member, the elongation at break of the sound absorbing member, the density of the sound absorbing member, and the number of cells of the sound absorbing member are measured in accordance with JIS (Japanese Industrial Standard)-K6400. The D method is adopted for testing the hardness of the sound absorbing member. Note that the dimensions and the cavity volume of the tire are measured in a state where the tire is mounted on a regular rim and inflated to the regular internal pressure. In particular, the cavity volume of the tire is the volume of a cavity portion formed between the tire and the rim in the condition described above. “Regular rim” is a rim defined by a standard for each tire according to a system of standards that includes standards on which tires are based, and refers to a “standard rim” in the case of JATMA (Japan Automobile Tyre Manufacturers Association, Inc.), refers to a “design rim” in the case of TRA (The Tire & Rim Association, Inc.), and refers to a “measuring rim” in the case of ETRTO (European Tire and Rim Technical Organization). However, when the tire is an original equipment tire, the volume of the cavity portion is calculated using a genuine wheel to which the tire is mounted. “Regular internal pressure” is an air pressure defined by standards for each tire according to a system of standards that includes standards on which tires are based, and refers to a “maximum air pressure” in the case of JATMA, refers to the maximum value in the table of “TIRE LOAD LIMITS AT VARIOUS COLD INFLATION PRESSURES” in the case of TRA, and refers to the “INFLATION PRESSURE” in the case of ETRTO. However, the air pressure which is displayed on the vehicle is used in a case where the tire is an original equipment tire.

### BRIEF DESCRIPTION OF DRAWINGS

FIG. 1 is a meridian cross-sectional view illustrating a pneumatic tire according to an embodiment of the present technology.

FIG. 2 is a cross-sectional view taken along an equator line of a pneumatic tire according to an embodiment of the present technology.

FIG. 3 is a graph showing the relationship between a temperature t (° C.) and an elongation at break y (%) of a sound absorbing member used in a pneumatic tire according to an embodiment of the present technology.

FIG. 4 is a graph showing the relationship between a hardness x (N/314 cm²) and an elongation at break y (%) in a sound absorbing member used in a pneumatic tire according to an embodiment of the present technology.

FIG. 5 is a meridian cross-sectional view illustrating a pneumatic tire according to a modified example of an embodiment of the present technology.

### DETAILED DESCRIPTION

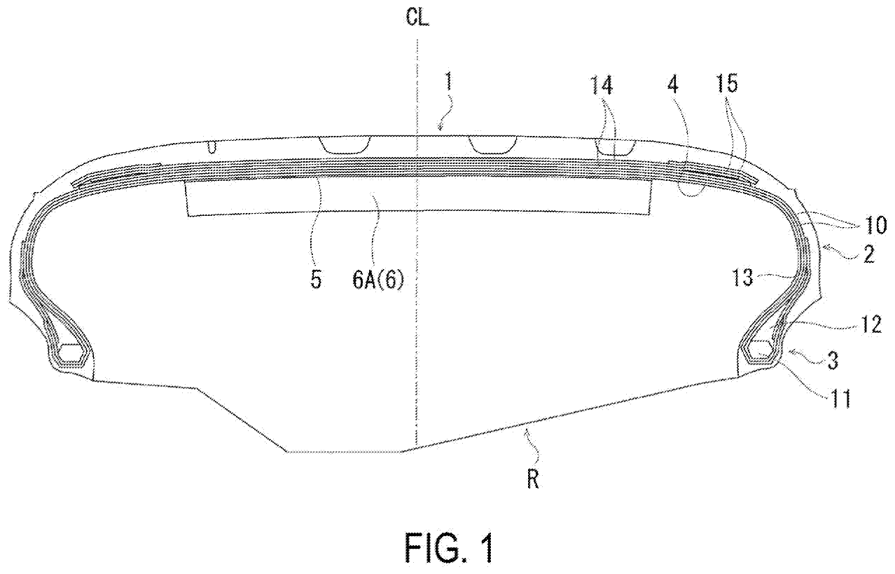

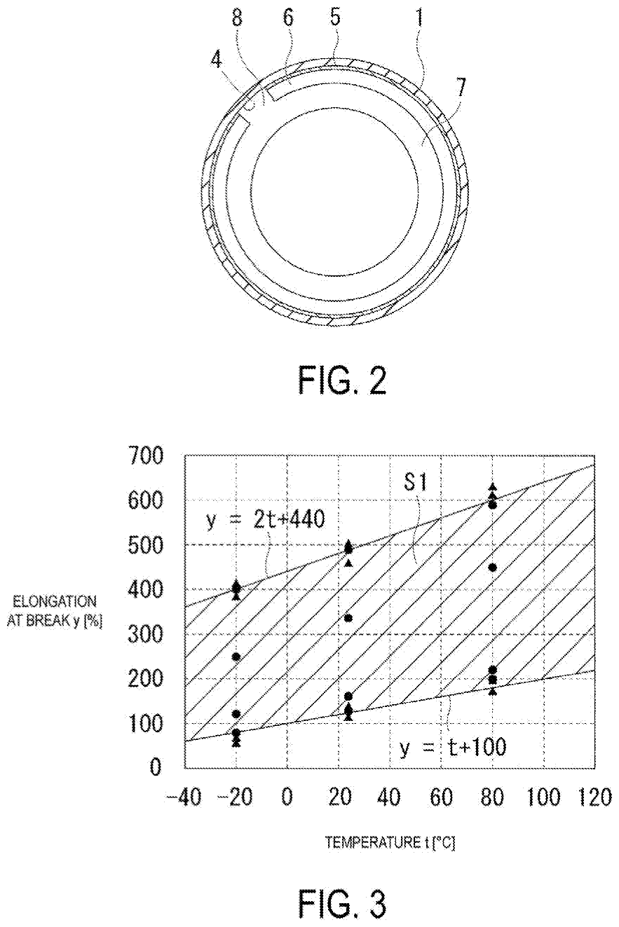

Configurations of embodiments of the present technology will be described in detail below with reference to the accompanying drawings. FIGS. 1 and 2 illustrate a pneumatic tire according to an embodiment of the present technology. In FIG. 1, the reference sign CL denotes the tire equator.

As illustrated in FIGS. 1 and 2, the pneumatic tire according to the present embodiment includes an annular tread portion 1 extending in the tire circumferential direction, a pair of sidewall portions 2 disposed on opposite sides of the tread portion 1, and a pair of bead portions 3 disposed toward the inside of the sidewall portions 2 in the tire radial direction.

At least one carcass layer 10 is mounted between the pair of bead portions 3, 3. The carcass layer 10 includes carcass cords arranged in the tire radial direction, and organic fiber cords are preferably used as the carcass cords. The carcass layer 10 is turned up around a bead core 11 disposed in each of the bead portions 3 from the inner side to the outer side of the tire. A bead filler 12 having a triangular cross-sectional shape is disposed on the outer circumferential side of each of the bead cores 11. Furthermore, an innerliner layer 13 is disposed in a region between the pair of bead portions 3, 3 on a tire inner surface.

Belt layers 14 are embedded on the outer circumferential side of the carcass layer 10 in the tread portion 1. The belt layers 14 each include a plurality of reinforcing cords that are inclined with respect to the tire circumferential direction, with the reinforcing cords of the different layers arranged in a crisscross manner. In the belt layers 14, the inclination angle of the reinforcing cords with respect to the tire circumferential direction ranges from, for example, 10° to 40°. Steel cords are preferably used as the reinforcing cords of the belt layers 14. To improve high-speed durability, at least one belt cover layer 15 formed by arranging reinforcing cords at an angle of 5° or less with respect to the tire circumferential direction is disposed on the outer circumferential side of the belt layers 14. Organic fiber cords of nylon, aramid, or the like are preferably used as the reinforcing cords of the belt cover layer 15.

Note that the tire internal structure described above represents a typical example for a pneumatic tire, and the pneumatic tire is not limited thereto.

In the pneumatic tire described above, as illustrated in FIGS. 1 and 2, a sound absorbing member 6 is fixed via an adhesive layer 5 to a region of the tire inner surface 4 corresponding to the tread portion 1 and extends along the tire circumferential direction. The adhesive layer 5 is not particularly limited, and, for example, an adhesive or double-sided adhesive tape can be used as the adhesive layer 5. The sound absorbing member 6 is made of a porous material with open cells and has predetermined noise absorbing properties based on the porous structure. Polyurethane foam is preferably used as the porous material of the sound absorbing member 6. Desirably, the sound absorbing member 6 does not contain water repellent. In the embodiment illustrated in FIG. 1, the sound absorbing member 6 includes a single band-like body 6A having a rectangular cross-sectional shape.

In the present technology, an elongation at break y (%) of the sound absorbing member 6 satisfies relationships of y≥t+100 and y≤2t+440 with respect to a temperature t (° C.) of the sound absorbing member 6. In particular, the relationships of y≥t+170 and/or y≤2t+350 are preferably satisfied. The relationship formulas for the temperature t and the elongation at break y of the sound absorbing member 6 are satisfied when the temperature t of the sound absorbing member 6 is at least in a range of −20° C. to 80° C.

Specifically, an area S1 of the hatched portion illustrated in FIG. 3 indicates the range of physical properties of the sound absorbing member 6 used in the pneumatic tire according to an embodiment of the present technology. In FIG. 3, when the elongation at break y of the sound absorbing member 6 is below the area S1, the sound absorbing member 6 easily separates or breaks during travel at low temperatures. When the elongation at break y of the sound absorbing member 6 is above the area S1, the hardness of the sound absorbing member 6 tends to decrease. As a result, the sound absorbing member 6 may be easily deformed during travel at high speeds.

Moreover, the sound absorbing member 6 preferably satisfies the aforementioned relationship formulas for the temperature t and the elongation at break y of the sound absorbing member 6 and a hardness x (N/314 cm²) and the elongation at break y (%) of the sound absorbing member 6 preferably satisfy relationships of 130≤y≤500, y≤−21x+2770, and x>80. In particular, the relationships of 80<x≤120, 140≤y≤490 and/or y≤−21x+2700 are more preferably satisfied, and the relationships of 80<x≤100, 150≤y≤480 and/or y≤−21x+2600 are most preferably satisfied. The hardness x and the elongation at break y of the sound absorbing member 6 are the hardness and elongation at break measured in standard conditions (temperature 23° C., relative humidity 50%).

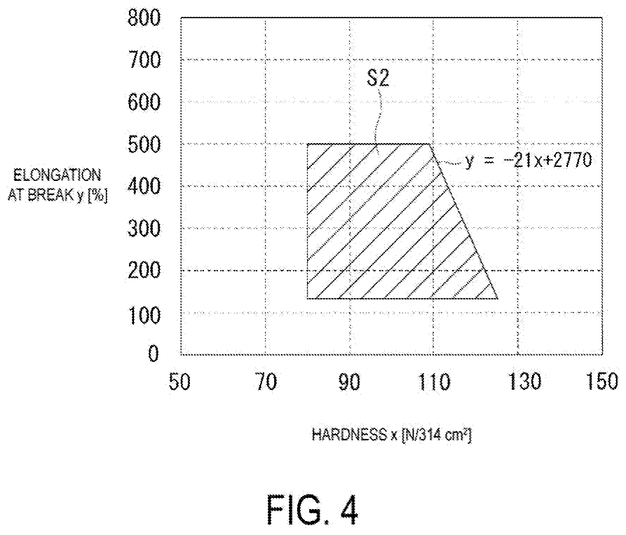

Specifically, an area S2 indicated by the hatched portion in FIG. 4 indicates the preferable range of the physical properties of the aforementioned sound absorbing member 6. In FIG. 4, when the hardness x of the sound absorbing member 6 exceeds the upper limit value specified by the relationship formulas described above, deformation of the tire cannot be followed during endurance of loading, and thus the sound absorbing member 6 is likely to separate. When the hardness is 80 N/314 cm² or less, the sound absorbing member 6 is deformed with compression set during travel at high speeds and cannot sufficiently provide a sound absorbing effect. In addition, when the elongation at break y of the sound absorbing member 6 is less than 130%, the sound absorbing member 6 is likely to easily break when the tire is highly deformed, and in particular, the tendency of breaking is significant at low temperatures.

The aforementioned pneumatic tire has a configuration in which the sound absorbing member 6 is adhered to the region of the tire inner surface 4 corresponding to the tread portion 1, the sound absorbing member 6 at a temperature of at least from −20° C. to 80° C. is disposed with the elongation at break y (%) of the sound absorbing member 6 and the temperature t (° C.) of the sound absorbing member 6 satisfying the relationships y≥t+100 and y≤2t+440. Thus, the sound absorbing member 6 can sufficiently ensure the sound absorbing effect during travel at high speeds, and the sound absorbing member 6 can be prevented from separating or breaking at low temperatures.

The aforementioned pneumatic tire preferably has a configuration in which the density of the sound absorbing member 6 is from 10 kg/m³ to 30 kg/m³ and the number of cells of the sound absorbing member 6 is from 30 cells/25 mm to 80 cells/25 mm. The density of the sound absorbing member 6 is set as such to give the sound absorbing member 6 a low density and reduce weight. This leads to a reduction in rolling resistance. Additionally, the number of cells of the sound absorbing member 6 is appropriately set so that fine air bubbles can be formed and the sound absorbing effect of sound absorbing member 6 can be sufficiently ensured.

The volume of the sound absorbing member 6 is preferably from 10% to 30% of the volume (cavity volume) of a cavity portion 7 formed between the tire and a rim R. Additionally, the width of the sound absorbing member 6 is preferably from 30% to 90% of the tire ground contact width. In this way, the sound absorbing effect of the sound absorbing member 6 can be sufficiently ensured, which leads to an improvement in quietness. When the volume of the sound absorbing member 6 is less than 10% of the cavity volume of the tire, the sound absorbing effect cannot be appropriately obtained. Additionally, when the volume of the sound absorbing member 6 of the cavity volume of the tire is greater than 30%, the noise reduction effect due to cavity resonance plateaus. As a result, the noise reduction effect cannot be further obtained.

As illustrated in FIG. 2, the sound absorbing member 6 preferably includes a missing portion 8 in at least one section in the tire circumferential direction. The missing portion 8 is a portion where the sound absorbing member 6 is not present along the tire circumference. The missing portion 8 is provided in the sound absorbing member 6. This allows for expansion due to inflation of the tire or shear strain of an adhering surface due to contact and rolling to be endured for a long period of time and for shear strain at the adhering surface of the sound absorbing member 6 to be effectively alleviated. One missing portion 8 or three to five missing portions 8 may be provided along the tire circumference. In other words, when two missing portions 8 are provided along the tire circumference, the tire uniformity significantly deteriorates due to mass unbalance, and when the six or more missing positions 8 are provided along the tire circumference, production costs significantly increase.

Note that in a case where two or more missing portions 8 are provided along the tire circumference, the sound absorbing member 6 is divided into portions in the tire circumferential direction. However, even in such a case, for example, the divided portions of the sound absorbing member 6 are connected to each other with another layer member such as the adhesive layer 5 made of double-sided adhesive tape. Thus, the sound absorbing member 6 can be treated as an integral member and can be easily applied to the tire inner surface 4.

The pneumatic tire described above preferably has a configuration in which the adhesive layer 5 is made of double-sided adhesive and the total thickness of the adhesive layer 5 is from 10 μm to 150 μm. By the adhesive layer 5 being configured as described above, the followability with respect to deformation during molding can be ensured. When the total thickness of the adhesive layer 5 is less than 10 μm, the strength of the double-sided adhesive tape is insufficient and the adhesiveness to the sound absorbing member 6 cannot be sufficiently ensured. When the total thickness of the adhesive layer 5 is greater than 150 μm, heat release is inhibited during travel at high speeds. Thus, high-speed durability easily deteriorates.

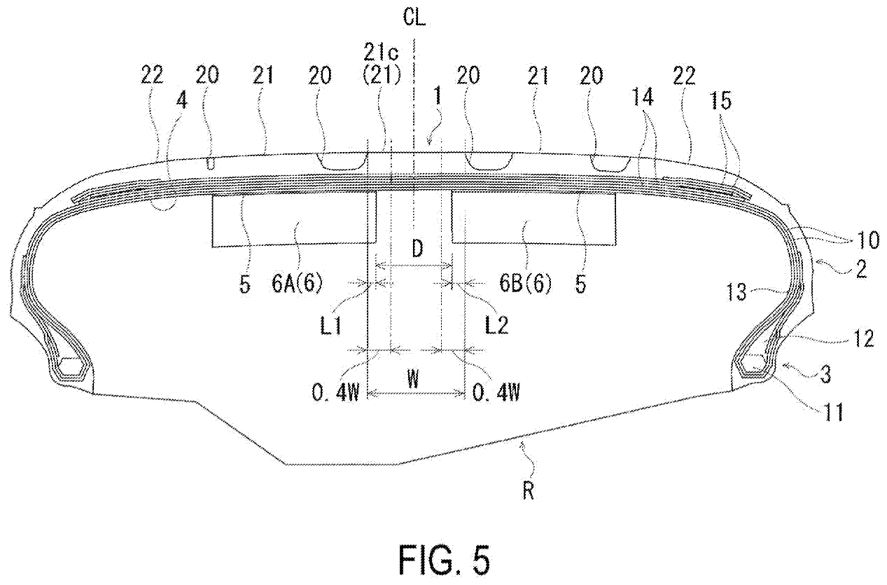

FIG. 5 illustrates a pneumatic tire according to a modified example of an embodiment of the present technology. As illustrated in FIG. 5, two or more circumferential grooves 20 extending in the tire circumferential direction are formed in the tread portion 1. One or more land portion 21 is defined by the circumferential grooves 20 between two circumferential grooves 20 adjacent in the tire lateral direction, and two (one on either side in the tire lateral direction) shoulder land portions 22 are defined at the tire lateral direction outer sides by the circumferential grooves 20 located outermost in the tire lateral direction. The land portion 21 includes a center land portion 21c disposed on the tire equator CL and continuously extending around the entire circumference of the tire.

Here, in the embodiment illustrated in FIG. 1, the sound absorbing member 6 includes a single band-like body 6A having a rectangular cross-sectional shape, and the band-like body 6A forming the sound absorbing member 6 is disposed straddling the tire equator CL. In contrast, in the embodiment illustrated in FIG. 5, the sound absorbing member 6 includes a first band-like body 6A and a second band-like body 6B, each having a rectangular cross-sectional shape. The first band-like body 6A forming the sound absorbing member 6 is disposed on one side in the tire lateral direction with respect to a position of 40% of a width W of the center land portion 21c from one end portion of the center land portion 21c on the one side in the tire lateral direction to the other side in the tire lateral direction. The second band-like body 6B forming the sound absorbing member 6 is disposed on the other side in the tire lateral direction with respect to a position of 40% of the width W of the center land portion 21c from one end portion of the center land portion 21c on the other side in the tire lateral direction to the one side in the tire lateral direction. In addition, a separation distance D between the first band-like body 6A and the second band-like body 6B is set to be 60% or greater of the width W of the center land portion 21c. Additionally, an overlap amount L of the band-shaped bodies 6A, 6B and the center land portion 21c (the sum of an overlap amount L1 of the first band-like body 6A and an overlap amount L2 of the second band-like body 6B) is set to be 40% or less of the width W of the center land portion 21c.

As described above, in the case where the pair of sound absorbing members 6 including the first band-like body 6A and the second band-like body 6B is applied, the pair of sound absorbing members 6 is disposed separated from each other so that heat is most easily generated in the tread portion 1, and the sound absorbing members 6 are directly attached at a position located away from the inner surface side of the center land portion 21c where heat accumulation is likely to occur; heat accumulation during travel at high speeds can be effectively inhibited, and the high-speed durability can be enhanced. In addition, the noise performance and the high-speed durability can be improved in a well-balanced manner.

The first band-like body 6A or the second band-like body 6B is disposed on the one side or the other side in the tire lateral direction with respect to the position 40% of the width W of the center land portion 21c from one end portion or the other end portion of the center land portion 21c in the tire lateral direction to the other side or the one side in the tire lateral direction. Note that, such structure includes the case where the end portion of the first band-like body 6A or the end portion of the second band-like body 6B on the inner side in the tire lateral direction matches with a position of 40% of the width W of the center land portion 21c from the one end or the other end of the center land portion 21c in the tire lateral direction to the other side or to the one side in the tire lateral direction.

### Example

Pneumatic tires according to Comparative Examples 1 to 4 and Examples 1 to 4 were manufactured. The pneumatic tires have a tire size of 275/35ZR20 and include an annular tread portion extending in the tire circumferential direction, a pair of sidewall portions disposed on opposite sides of the tread portion, a pair of bead portions disposed toward the inside of the sidewall portions in the tire radial directions, and one of sound absorbing members A to H having different physical properties attached via an adhesive layer to the inner surface of the tread portion along the tire circumferential direction. Additionally, for the sound absorbing members A to H attached to the respective test tires, the hardness (N/314 cm²) of the sound absorbing member, the density (kg/m³) of the sound absorbing member, and the number of cells of the sound absorbing member (cells/25 mm) were set as indicated in Table 1.

In the test tires, when the temperature of the sound absorbing member was −20° C., 23° C., and 80° C., the elongation at break (%) of each of the sound absorbing members A to H was measured. The results are indicated in Table 1. Furthermore, in FIG. 3, the physical properties of the sound absorbing members A to D attached to the tires of Comparative Examples 1 to 4 are respectively indicated by triangle marks, and the physical properties of the sound absorbing members E to H attached to the tires of Examples 1 to 4 are indicated by round marks. Moreover, the high-speed durability with camber angle and the low-temperature durability were evaluated for each of the test tires in accordance with the following test methods. The results are also indicated in Table 1.

High-Speed Durability with Camber Angle:

Each test tire was mounted on a wheel having a rim size of 20×9J, and a running test was performed using a drum testing machine under the conditions: running speed of 330 km/h, air pressure of 290 kPa, load of 6 kN, negative camber angle of −3°, and running distance of 400 km. After testing, whether the sound absorbing member is deformed with compression set was visually confirmed.

### Low-Temperature Durability:

Each test tire was mounted on a wheel having a rim size of 20×9 1/2J, and a running test was performed using a drum testing machine under the conditions: temperature of −20° C., running speed of 81 km/h, air pressure of 160 kPa, load of 5 kN, and running distance of 6480 km. After testing, whether the sound absorbing member is broken was visually confirmed.

TABLE 1

| | | Comparative | Comparative | Comparative | Comparative |
|---|---|---|---|---|---|
| | | Example 1 | Example 2 | Example 3 | Example 4 |
| Attached sound absorbing | | A | B | C | D |
| member (A to H) | | | | | |
| Elongation at break of | −20° C. | 70 | 405 | 60 | 380 |
| sound absorbing | 23° C. | 110 | 500 | 130 | 460 |
| member (%) | 80° C. | 170 | 610 | 195 | 620 |
| Hardness of sound absorbing | | 80 | 80 | 80 | 80 |
| member (N/314 cm²) | | | | | |
| Density of sound absorbing | | 25 | 25 | 25 | 25 |
| member (kg/m³) | | | | | |
| Number of cells of sound | | 50 | 50 | 50 | 50 |
| absorbing member (cells/25 | | | | | |
| mm) | | | | | |
| High-speed durability with | | Not | Deformed | Not | Deformed |
| camber angle | | deformed | | deformed | |
| Low-temperature durability | | Broken | Not broken | Broken | Not broken |
| | | | (no outer | | (no outer |
| | | | damage) | | damage) |
| | | Example 1 | Example 2 | Example 3 | Example 4 |
| Attached sound absorbing | | E | F | G | H |
| member (A to H) | | | | | |
| Elongation at break of | −20° C. | 80 | 400 | 120 | 250 |
| sound absorbing | 23° C. | 125 | 485 | 160 | 330 |
| member (%) | 80° C. | 200 | 590 | 220 | 450 |

| | | | | |
|---|---|---|---|---|
| Hardness of sound absorbing | 85 | 85 | 90 | 110 |
| member (N/314 cm²) | | | | |
| Density of sound absorbing | 25 | 25 | 25 | 25 |
| member (kg/m³) | | | | |
| Number of cells of sound | 50 | 50 | 50 | 50 |
| absorbing member (cells/25 | | | | |
| mm) | | | | |
| High-speed durability with | Not | Not | Not | Not |
| camber angle | deformed | deformed | deformed | deformed |
| Low-temperature durability | Not broken | Not broken | Not broken | Not broken |
| | (no outer | (no outer | (no outer | (no outer |
| | damage) | damage) | damage) | damage) |

As seen from Table 1, the sound absorbing members E to H attached to the tires of Example 1 to 4 satisfy the relationship formulas, which are defined by the present technology for the temperature and the elongation at break of the sound absorbing member. In comparison with Comparative Example 1, the low-temperature durability of the pneumatic tires of Examples 1 to 4 was improved. Additionally, in comparison with Comparative Example 2, the high-speed durability with camber angle of the pneumatic tires of Examples 1 to 4 was improved.

In Comparative Example 3, the sound absorbing member C did not satisfy the relationship formulas, which are defined by the present technology for the temperature and the elongation at break of the sound absorbing member at −20° C., and breaking of the sound absorbing member was confirmed in the low-temperature durability test. In Comparative Example 4, the sound absorbing member D did not satisfy the relationship formulas, which are defined by the present technology for the temperature and the elongation at break of the sound absorbing member at 80° C., and deformation of the sound absorbing member was confirmed in the test of the high-speed durability with camber angle.

1. A pneumatic tire comprising:
a tread portion extending in a tire circumferential direction and having an annular shape;
a pair of sidewall portions disposed on opposite sides of the tread portion; and
a pair of bead portions disposed toward the inside of the sidewall portions in a tire radial direction; wherein
a sound absorbing member is fixed via an adhesive layer to an inner surface of the tread portion along the tire circumferential direction, and
when a temperature t (° C.) of the sound absorbing member is at least in a range from −20° C. to 80° C., an elongation at break y (%) and the temperature t (° C.) of the sound absorbing member satisfy relationships y≥t+100 and y≤2t+440.

2. The pneumatic tire according to claim 1, wherein a hardness x (N/314 cm²) of the sound absorbing member and the elongation at break y (%) of the sound absorbing member satisfy relationships 130≤y≤500, y≤−21x+2770, and x>80.

3. The pneumatic tire according to claim 1, wherein the sound absorbing member has a density of from 10 kg/m³ to 30 kg/m³, and
a number of cells of the sound absorbing member is from 30 cells/25 mm to 80 cells/25 mm.

4. The pneumatic tire according to claim 1, wherein the sound absorbing member has a volume from 10% to 30% of a cavity volume of the pneumatic tire.

5. The pneumatic tire according to claim 1, wherein the sound absorbing member comprises a single band-like body having a rectangular cross-sectional shape, and
the band-like body forming the sound absorbing member is disposed straddling a tire equator.

6. The pneumatic tire according to claim 1, further comprising a center land portion disposed on the tread portion on a tire equator and continuously extending around the tread portion around an entire tire circumference;
and wherein
the sound absorbing member comprises a first band-like body and a second band-like body, each one having a rectangular cross-sectional shape;
the first band-like body forming the sound absorbing member is disposed on one side in a tire lateral direction with respect to a position of 40% of a width of the center land portion from one end portion of the center land portion on the one side in the tire lateral direction to the other side in the tire lateral direction;
the second band-like body forming the sound absorbing member is disposed on the other side in the tire lateral direction with respect to a position of 40% of the width of the center land portion from one end portion of the center land portion on the other side in the tire lateral direction to the one side in the tire lateral direction; and
the first band-like body forming the sound absorbing member and the second band-like body forming the sound absorbing member are separated from each other by 60% or greater of the width of the center land portion.

7. The pneumatic tire according to claim 1, wherein the adhesive layer comprises a double-sided adhesive tape, and
the adhesive layer has a total thickness of from 10 μm to 150 μm.

8. The pneumatic tire according to claim 1, wherein the sound absorbing member comprises a missing portion in at least one section in the tire circumferential direction.

9. The pneumatic tire according to claim 2, wherein the sound absorbing member has a density of from 10 kg/m³ to 30 kg/m³, and
a number of cells of the sound absorbing member is from 30 cells/25 mm to 80 cells/25 mm.

10. The pneumatic tire according to claim 9, wherein the sound absorbing member has a volume from 10% to 30% of a cavity volume of the pneumatic tire.

11. The pneumatic tire according to claim 10, wherein the sound absorbing member comprises a single band-like body having a rectangular cross-sectional shape, and
the band-like body forming the sound absorbing member is disposed straddling a tire equator.

12. The pneumatic tire according to claim 11, further comprising a center land portion disposed on the tread portion on a tire equator and continuously extending around the tread portion around an entire tire circumference; and wherein
the sound absorbing member comprises a first band-like body and a second band-like body, each one having a rectangular cross-sectional shape;
the first band-like body forming the sound absorbing member is disposed on one side outward in a first direction in a tire lateral direction with respect to from a position of 40% of a width of the center land portion, the position being 40% of the width from one an end portion of the center land portion on the one side in the first direction in the tire lateral direction to the other side toward a second direction in the tire lateral direction;
the second band-like body forming the sound absorbing member is disposed on the other side outward in the second direction in the tire lateral direction with respect to from a position of 40% of the width of the center land portion, the position being 40% of the width from one an end portion of the center land portion on the other side in the second direction in the tire lateral direction to the one side toward the first direction in the tire lateral direction; and
the first band-like body forming the sound absorbing member and the second band-like body forming the sound absorbing member are separated from each other by a distance 60% or greater of the width of the center land portion.

13. The pneumatic tire according to claim 12, wherein the adhesive layer comprises a double-sided adhesive tape, and
the adhesive layer has a total thickness of from 10 μm to 150 μm.

14. The pneumatic tire according to claim 13, wherein the sound absorbing member comprises a missing portion in at least one section in the tire circumferential direction.
